(19) United States
(12) Patent Application Publication
(10) Pub. No.: US 2026/0259149 A1
(43) Pub. Date: Sep. 3, 2026

(54) METHOD AND SYSTEM FOR COORDINATING CONTAMINATION REMOVAL THAT INCLUDES AN AUTOMATED INSPECTION SYSTEM THAT IS INTEGRATED WITHIN THE CONTAMINATION REMOVAL PROCESS

(71) Applicant: JCAI Inc., Cambridge (CA)

(72) Inventors: Jeffery Paul CAMPBELL, Cambridge (CA); Sadeem AL ATTAR, Cambridge (CA)

(21) Appl. No.: 19/163,886

(22) PCT Filed: Mar. 7, 2024
(86) PCT No.: PCT/CA2024/050280

§ 371 Date: Sep. 10, 2025

Related U.S. Application Data
(60) Provisional application No. 63/451,274, filed on Mar. 10, 2023.

(51) Int. Cl. G01N 21/94; B64D 15/22; B64F 5/20; G06T 7/90

(52) U.S. Cl. CPC G01N 21/94; B64D 15/22; B64F 5/20; G06T 7/90; G06T 2207/10048; G06T 2207/30252

(57) ABSTRACT

The disclosure is directed at a method and apparatus for coordinating a contamination removal treatment for an aircraft that includes an inspection that is integrated within the contamination removal treatment. The method and system include receiving a signal indicating the aircraft is ready for the contamination removal treatment; obtaining images or video of surfaces of the aircraft at a location for performing contamination removal treatment; processing the images or video to determine if there is any contamination on the surfaces of the aircraft; and determining if there is a need for performing contamination removal treatment.

### CROSS-REFERENCE TO OTHER APPLICATIONS

The current disclosure claims priority from United States Provisional Patent Application No. 63/451,274 filed Mar. 10, 2023 which is hereby incorporated by reference.

### FIELD

The disclosure is generally directed at the field of aviation and, more specifically, at a method and system for coordinating contamination removal that includes an inspection that is integrated within the contamination removal process.

### BACKGROUND

In the winter season, before aircraft are allowed to take off, aircraft may have to undergo a contamination removal process. The contamination removal process typically results in the aircraft undergoing a de-icing treatment in order to remove excess snow, sleet and/or ice that has accumulated on various surfaces of the aircraft. This contamination may adversely affect an aircraft during its flight.

Currently, aircraft undergo manual inspection of the aircraft either when it is at a terminal or gate or after it has completed its de-icing treatment. Generally, inspections that are performed on the aircraft at the terminal or gate are performed by the pilot or a co-pilot looking directly at the different surfaces of the aircraft through windows within the aircraft. In some scenarios, the pilot or co-pilot may not be able to see all the critical external surfaces of the aircraft such as with high wing aircraft or cargo aircraft with no passenger windows. Without visual confirmation of a presence or absence of contamination on these external surfaces, the pilot or co-pilot will request their aircraft to be de-iced. This is costly from a time and monetary perspective for airlines as this incurs additional charges and/or delays a departure time especially in scenarios where there is no contamination. In addition, airports flight schedules are affected due to the additional steps before departure. It will be appreciated that if an aircraft is unable to take off at its designated time slot, this affects later flights as there is a need to reschedule the departure for the aircraft after it has gone through the further contamination removal.

For inspections of the aircraft after the treatment, the inspection is generally performed by de-icing personnel after the aircraft has left the de-icing location. If it is determined that there is still contamination on a surface of the aircraft, the aircraft is then required to return to a queue to receive a further contamination removal treatment. Again, this negatively affects later flights as there is a need to reschedule the departure for this aircraft.

Therefore, there is provided a novel method and system for coordinating contamination removal that includes an inspection that is integrated within the contamination removal process.

### SUMMARY

The disclosure is directed at a method and system for coordinating contamination removal that includes an automated or semi-automated inspection system utilizing sensors or cameras that is integrated within the contamination inspection and removal process. In another embodiment, results of the inspection may be captured in an electronic post deicing report or record transferred to a database.

In one embodiment, the disclosure provides confirmation imaging and/or condition status apparatus during the contamination removal treatment. The confirmation image and/or condition status apparatus includes the use of a set of cameras or sensors that are located within a predetermined location within an airport, such as a contamination removal location or at the terminal gate, to capture data (in the form of images and video) associated with the entire and/or specific surfaces of an aircraft.

The data is then processed by the disclosure to segment or divide the data into different segments associated with aircraft parts, such as, but not limited to, the nose, the body, the wings, the tail, the nacelle, the propeller, and the control surfaces. The different segments may also be associated with critical surfaces that need to be inspected for contamination. These segmented images or video can then be further processed to determine if there is any contamination on the surface of the aircraft in these segmented images or video. The electronic visual inspection process incorporates ice detection software which uses artificial intelligence (AI) and/or machine learning coupled with segmentation software which enables the visual technology to not only identify contamination, and its location but also, differentiate between surfaces, so that in low visual situations or where a completely automated deicing operation using autonomous applicators are performing the operation, that the inspection is properly differentiating between these specific aircraft surfaces and the environment such as the ground or any foreign object in the view of the camera/sensor.

In one aspect of the disclosure, there is provided a method for coordinating a contamination removal treatment for an aircraft including receiving a signal indicating the aircraft is ready for the contamination removal treatment; obtaining images or video of surfaces of the aircraft at a location for performing contamination removal treatment; processing the images or video to determine if there is any contamination on the surfaces of the aircraft; and determining if there is a need for performing contamination removal treatment.

In another aspect, the method includes before receiving a signal, receiving a request for the contamination removal treatment; determining the location for performing the contamination removal treatment; and transmitting a signal to the aircraft, the signal including the location for performing the contamination removal treatment. In a further aspect, obtaining images or video of surfaces of the aircraft includes capturing images or video of external surfaces of the aircraft using thermal or infrared cameras. In yet a further aspect, processing the images or video includes processing the images or video using heat map technology to determine temperatures of surfaces of the aircraft; determining if any of the determined temperatures meet a predetermined criteria; and determining a further contamination removal treatment is required if the determined temperatures do not meet the predetermined criteria.

In another aspect, processing the images or video includes processing the images or video to determine a level of contamination on surfaces of the aircraft; and requesting a further contamination removal treatment if the level of contamination on the surfaces of the aircraft do not meet a predetermined criteria or providing an aircraft ready signal if the level of contamination on the surfaces of the aircraft meet the predetermined criteria. In yet another aspect, processing the images or video to determine a level of contamination on surfaces of the aircraft includes processing the image or video using artificial intelligence (AI) models. In yet a further aspect, processing the images or video includes segmenting the aircraft into different aircraft zones; and sorting the images or video into the different aircraft zones. In an aspect, processing the images or video further includes receiving a request for processing at least one of the images or video of one of the different aircraft zones; and determining a level of contamination on surfaces of the aircraft within the different aircraft zones; and requesting a further contamination removal treatment if the level of contamination within at least one of the requested different aircraft zones do not meet a predetermined criteria or providing an aircraft ready signal if the level of contamination within all of the requested different aircraft zones meet the predetermined criteria. In yet another aspect, before receiving a signal indicating the aircraft is ready for the contamination removal treatment, the method includes determining a contamination removal treatment plan.

In another aspect of the disclosure, there is provided a system for coordinating a contamination removal treatment for an aircraft including a set of cameras located at a contamination removal treatment location; a controller for communication with the set of cameras to obtain images or video of surfaces of the aircraft and for processing the images or video to determine if there is contamination on the surface of the aircraft after the contamination removal treatment.

In a further aspect, the controller includes a communication module for communicating with other communication devices; and a contamination module for processing the images or videos. In yet a further aspect, the controller further includes a segmentation module for sorting the images and videos into different aircraft zones. In another aspect, the system further includes a contamination removal apparatus communication device for communicating with the controller to perform the contamination removal treatment.

### BRIEF DESCRIPTION OF THE DRAWINGS

Embodiments of the present disclosure will now be described, by way of example only, with reference to the attached Figures.

FIG. 1a is a schematic diagram of an environment for coordinating contamination removal that includes an automated inspection system that is integrated within the contamination removal process;

FIG. 1b is a schematic diagram of a system for coordinating contamination removal that includes an automated inspection system that is integrated within the contamination removal process;

FIG. 1c is a schematic diagram of one embodiment of a contamination removal location;

FIG. 2 is a flowchart outlining a method of coordinating contamination removal that includes an automated inspection system that is integrated within the contamination removal process;

FIGS. 3a to 3k are images produced by a segmentation module;

FIG. 4a is a flowchart showing a method of transmitting coordination removal location information to a pilot device;

FIGS. 4b to 4j are screenshots of displays that are shown on different devices in the environment for coordinating contamination removal that includes an inspection that is integrated within the contamination removal process;

FIGS. 5a and 5b show a flowchart outlining another method of coordinating contamination removal that includes an inspection that is integrated within the contamination removal process;

FIGS. 6a and 6b are images produced upon request for a pilot or dispatcher; and

FIG. 7 is an image showing aircraft tracking.

### DETAILED DESCRIPTION OF THE EMBODIMENTS

The disclosure is directed at a method and system for coordinating contamination removal that includes an inspection that is integrated within the contamination removal process. In one embodiment, the disclosure includes a set of cameras that provide data such as in the form of images and/or video of external surfaces of an aircraft. The data is then processed by the system to provide an automated inspection of the aircraft during the contamination removal process.

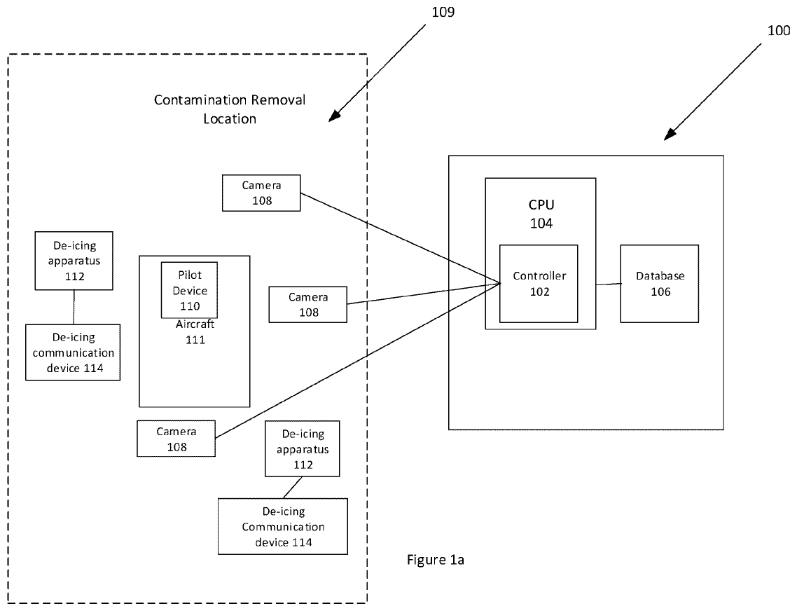

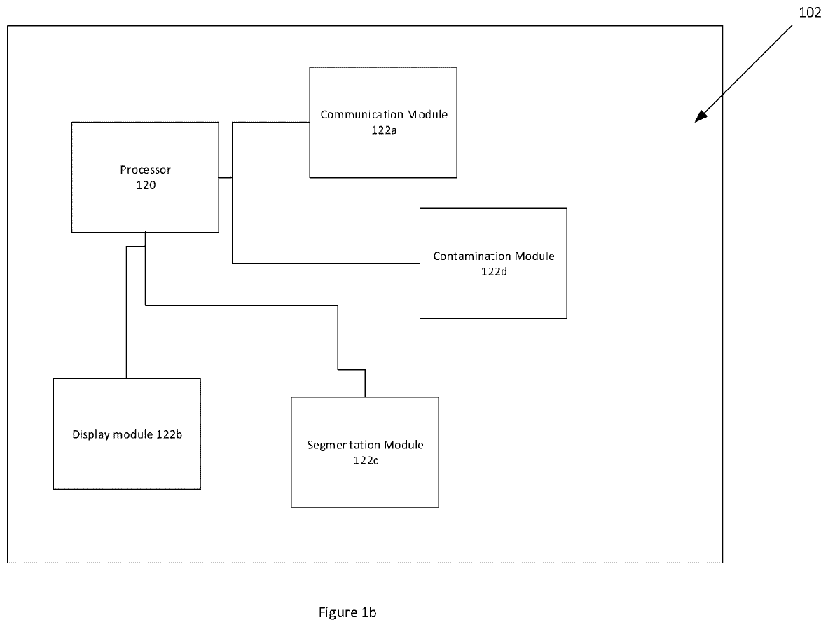

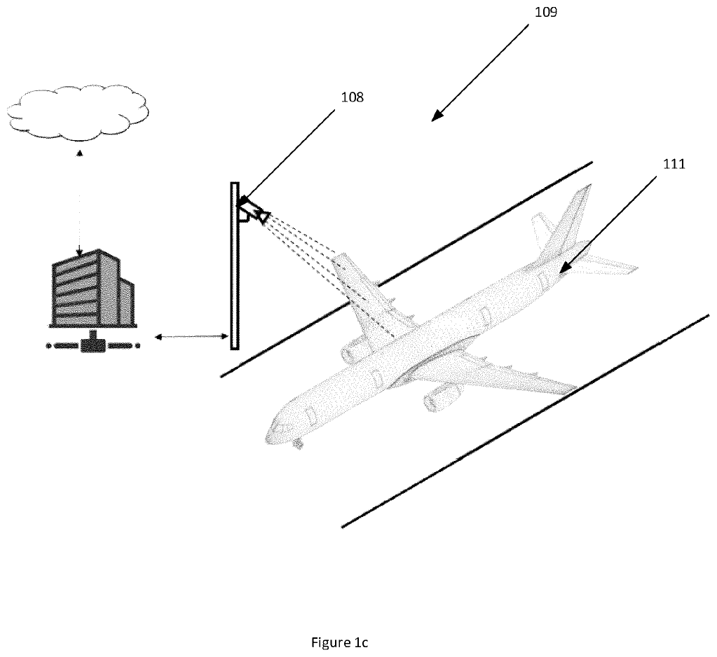

Turning to FIG. 1a, a schematic diagram of an environment for contamination removal on a surface of an aircraft is provided. An advantage of the disclosure is the integration of automated inspection of external surfaces of an aircraft for contamination during the contamination removal process.

As shown in FIG. 1a, a system for coordinating a contamination removal process that includes apparatus for an automated or semi-automated inspection 100 communicates with external parties to coordinate a contamination removal process for an aircraft and to coordinate automated or semi-automated contamination inspection of the aircraft. It is understood that while the disclosure refers to a single aircraft, the system may be able to coordinate contamination removal treatments for all aircraft within an airport, the treatment including automated inspection during the treatment.

The system 100 includes a controller 102 that may be stored, located or integrated within a central processing unit (CPU) 104 such as, but not limited to, a server or a cloud based system. The CPU 104 may be connected to an external database 106 or a database (not shown) may be located within the CPU 104.

The controller 102 enables the system 100 to communicate with different components of the system 100 (as described below) and other communication devices that are external to the system 100. As discussed above, the controller 102 may also be stored and executed in a cloud-based network.

The system 100 is in communication with a set of cameras 108 or sensors that are associated with, or located within, contamination removal and/or inspection locations 109 where de-icing (or contamination removal) may take place. Examples of contamination removal locations include, but are not limited to, a contamination removal, or de-icing, bay within a remote or centralized de-icing facility; a gate location where passengers board an aircraft; a designated de-icing location within an airport, or another designated location within the airport. In some embodiments, the cameras or sensors 108 may form part of the system 100. The controller 102 communicates with the cameras 108 or sensors to perform specific functions relating to an automated inspection of or capture of data associated with external surfaces of the aircraft that is integrated within the contamination removal process. This inspection may be prior to and/or after the contamination removal process or treatment has been performed.

Each of the set of cameras 108 may be permanently mounted to structures within the contamination removal location 109 or may be mounted to mobile platforms that enable the set of cameras 108 to be moved around the contamination removal location 109 such that the set of cameras 108 are able to capture images or video of an entire aircraft 111 when it is parked or braked in the contamination removal location 109.

In one embodiment, the controller 102 communicates with a pilot (or aircraft personnel) of the aircraft 111 via a pilot device 110 that is located within the aircraft 111, such as within the cockpit of the aircraft 111. The pilot device 110 may be a tablet, a laptop computer, a Smartphone and the like where a pilot (or co-pilot) is able to electronically communicate with the controller 102.

The contamination removal location 109 further includes at least one contamination removal, or de-icing, apparatus 112, such as, but not limited to, a de-icing machine, robot or vehicle. The de-icing apparatus 112, which may be controlled by an on-board operator or may be an autonomous vehicle, includes a de-icing apparatus communication device 114 that enables the controller 102 to electronically, or digitally, communicate with the de-icing apparatus 112 or an operator of the de-icing apparatus 112. In some embodiments, the communication may relate to computer vision based awareness.

Turning to FIG. 1b, a schematic diagram of an embodiment of the controller of FIG. 1a is shown. In the current embodiment, the controller 102 includes a processor 120 that executes a set of modules 122 that perform different functionality to enable the method and system for coordinating an automated or semi-automated contamination inspection that is integrated within a contamination removal process. In the current embodiment, the set of modules 122 include a communication module 122a, a display module 122b, a segmentation module 122c and a contamination module 122d.

The communication module 122a enables the controller 102 to communicate with the pilot device 110, the de-icing apparatus communication device 114, and/or each of the set of cameras/sensors 108. The communication module 122a may also communicate with other communication devices that may or may not form part of the system 100 or contamination removal treatment environment such as, but not limited to, a dispatcher.

In some embodiments, the communication module 122a communicates with the set of cameras/sensors 108 to trigger an automated or semi-automated inspection (or data capture) process. The inspection process may be initiated via a pilot request for an inspection through the pilot device or a dispatch request through a dispatch communication device to the controller 102.

In some embodiments, the request for inspection is initiated after the aircraft 111 has parked at the contamination removal location 109. The controller 102 may also communicate, via the communication module 122a, to provide aircraft type information to the set of cameras 108 so that the cameras/sensor visual systems can automatically configure themselves to appropriately capture or obtain the requested aircraft surface data based on the aircraft type and/or configuration information. In other words, based on the aircraft type (or size) information provided by the controller 102, the cameras 108 automatically adjust their settings, such as, but not limited to, location, pan, tilt or zoom, so that the set of cameras 108 can capture data associated with the entire surface and/or the critical surfaces of the aircraft. Critical surfaces of an aircraft may include, but are not limited to, rudders and leading edges on the tail ailerons or flaps, slats, and leading edges on the wings.

The controller 102 may also include a display module 122b that generates images and the like for display on or communication devices in communication with the controller 102. For example, in some embodiments, the display module 122b may generate segmented images of the aircraft with contamination areas on the external surfaces highlighted to visually aid the users who are looking at the inspection results.

The segmentation module 122c receives data, such as in the form of images and/or video, that is transmitted to the controller 102 and then processes this data. In one embodiment, the controller 102 processes the data using an artificial intelligence (AI) model to divide, separate, categorize or segment the images and/or video with respect to different surfaces or areas of the aircraft. In one embodiment, the segmentation module 122c detects the surfaces of the aircraft within the images and then sorts the images accordingly. In another embodiment, the segmentation module 122c detects the critical surfaces of the aircraft within the images and sorts the images accordingly. The identified surfaces information (such as in the form of images or videos of segmented aircraft components) is passed on to the contamination module 122d to focus the contamination module inspection to the identified surfaces such as by using the AI model built to identify and detect contaminations.

In another embodiment, the system 100 may segment the aircraft before transmitting signals or instructions to the set of cameras 108 in order to have certain cameras capture data from specific segments of the aircraft. Alternatively, the set of cameras may segment the aircraft prior to capturing the images or videos in order to differentiate or categorize the images in relation to segments of the aircraft that are being treated from other vehicles, such as, but not limited to, de-icing vehicles trucks or other unrelated objects to remove or avoid artifacts or obstructions from the captured data. In another embodiment, the segmentation module 122c receives data with respect to the aircraft and then segments the data into different aircraft areas such as, but not limited to, the nose, the body, the wings and the tail of the aircraft. The controller 102 may then assign some of the set of cameras 108 to different aircraft segments. It is understood that the aircraft can be segmented into more or less segments depending on the design of the system 100. In some embodiments, the segments may be mapped to a three-dimensional (3D) special grid whereby the different aircraft surfaces may be bounded within a distinct set of spatial co-ordinates within the special grid. The different sets of spatial coordinates may be used by the controller 102 to select a specific special coordinate zone in the 3D grid of an aircraft to be processed by the contamination module 122c or as instruction to the cameras to further inspect specific spatial zones of the aircraft surfaces. The information may be in the form of segment coordinates or may be an instruction to inspect, for example, the nose segment.

In one embodiment, the contamination module 122d can then communicate with the segmentation module 122c to retrieve the images that are in the nose segment set of coordinates within the spatial grid generated by the segmentation module 122c. In one embodiment, the contamination module 122d receives information, such as from the processor 120, with respect to the surface areas of the aircraft to inspect. The contamination module 122d may scan for contamination in the pre-deicing stage or for contamination and fluid failure in the post deicing stage.

FIG. 1c provides a schematic diagram of a contamination removal location 109 where a camera 108 is directed at an aircraft 111 to obtain data (images and/or video) of the entire aircraft or a specific surface or surfaces of the aircraft. It is understood that the embodiment of FIG. 1c is only one possible setup of a set of cameras at a contamination removal location. In other embodiments, more than one camera, either pole-mounted or installed on mobile platforms, are positioned adjacent to an aircraft at the contamination removal location. As discussed above, the contamination removal location may be a terminal gate, a remote but designated area within the airport, or located within a contamination removal facility.

In one embodiment, the set of cameras examine the entire external surface of an aircraft for contamination before the contamination removal treatment process is performed on the aircraft. This may be seen as a pre-deicing inspection. Contamination may be seen as one or more foreign objects on a surface or surfaces of an aircraft such as, but not limited to, ice, snow, slush and the like, or any combination.

The set of cameras/sensors can be installed at any or all these locations 109 to inspect an aircraft for contaminants or contamination before a contamination removal treatment is performed on the aircraft. The set of cameras/sensors may also inspect the same aircraft after the contamination removal treatment is complete before it leaves the contamination removal location 109, which may be referred to as post-deicing inspection. The post-deicing inspection may be used to determine or look for signs of fluid failure and/or contamination after operators inform the system that the contamination removal treatment has been completed.

A pre-deicing inspection of the aircraft may provide information to the pilot and others, such as, but not limited to, a dispatcher or other airport personnel who may be involved with the aviation industry, with respect to the presence of contamination on a surface of the aircraft. If there is contamination detected, the system may transmit a message (with or without relevant images or video) to other devices in communication with the system (or controller) 102. In some embodiments, for messages with images, the images may identify zones of contamination on external surfaces of the aircraft by highlighting these zones on the image. In other embodiments, the message may include images of specific segments of interest with or without contamination to other communication devices.

A post-deicing inspection may provide information to the pilot and/or other aviation stakeholders with information to determine if there is any contamination on the surface of the aircraft after the treatment has been performed. For post-de-icing inspections, the contamination may also include fluid failure conditions where the de-icing fluid was not successful in removing the contamination. If contamination is detected, the system may transmit a message (with or without images) to devices that are in communication with the system (or controller).

If there is no contamination detected in the post-deicing inspection, the system may transmit an all-clear or all-clear message to connected communication devices. Based on this message, the pilot may be given the authority to proceed to a runway for take-off.

In some embodiments, the set of cameras are in communication with a cloud-based network (or a Cloud network) to transmit data and receive commands from the controller 102. In one embodiment, each of the cameras is equipped to pan, zoom and/or tilt such that the instructions from the controller may include commands to adjust the aim of the cameras to any aircraft type or configuration. This may also assist the cameras to accurately find or locate the external surfaces.

Although only one camera is shown on the post in FIG. 1c, multiple cameras may be mounted to a post. Alternatively, there may also be multiple posts surrounding the aircraft, each with one or more cameras. The cameras can be visible light camera or a combination of visible light and infrared cameras that may work in conjunction to inspect the surfaces.

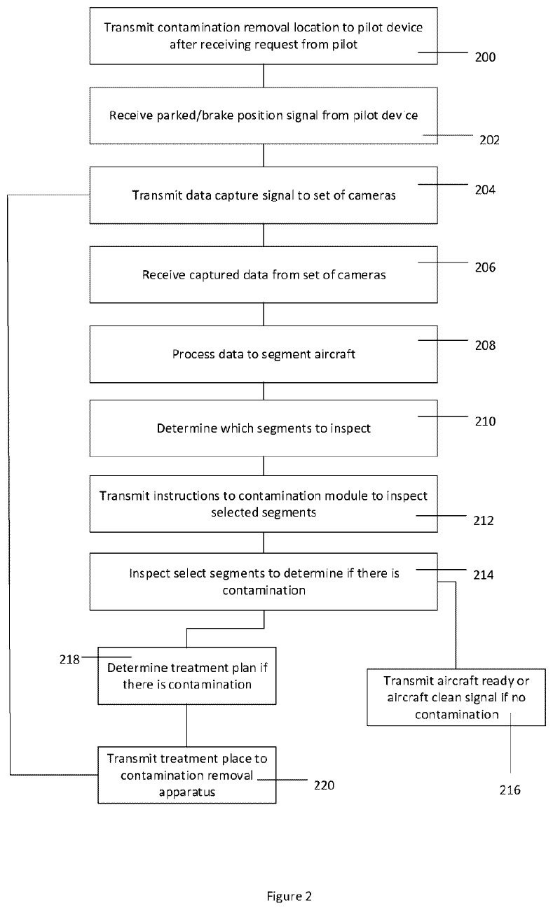

Turning to FIG. 2, a flowchart outlining a method of integrating a contamination inspection within a contamination removal treatment process is shown.

In operation, after a pilot has requested contamination removal (such as via the pilot device), the controller 102 transmits a signal or message to the pilot device providing a contamination removal location for the aircraft (200). The contamination removal request received from the pilot may include information associated with the aircraft such as, but not limited to, at least one of aircraft identification, aircraft type, aircraft size, aircraft dimensions and the like.

In one embodiment, upon receiving the request, the controller 102 retrieves scheduling information with respect to contamination removal locations and/or available contamination removal apparatus and determines a contamination removal location for the aircraft. The controller 102 then transmits this information to the pilot so that the pilot knows where and when to go for the contamination removal treatment. The determination may also include a time slot for the treatment. In some embodiments, the contamination removal location may be at the gate such that the aircraft may not have to move. In other embodiments, the pilot may be required to travel from its current location or position to the designated or determined contamination removal location.

Upon arrival at the contamination removal location, the pilot transmits (such as via the pilot device) a parked/brake-set position signal (which may be seen as a brake set signal) to the controller 102 which is received and processed by the controller (202). The parked/brake-set position signal indicates that the aircraft is ready for the contamination removal process or treatment to begin. In other embodiments, the pilot device may be used to transmit an aircraft ready signal to the controller.

Once the parked/brake-set position or aircraft ready signal is received by the controller, the controller transmits a data capture signal to the set of cameras to obtain images and/or video of the stationary or parked aircraft (204). In the following, the word “data” represents either or both image data and/or video data. The data capture signal may include information such as, but not limited to, type and configuration of aircraft and area for data capture, date and time and/or flight identification (ID). In other embodiments, the data capture signal may include segments of the aircraft that require data to be captured.

In some embodiments, the set of cameras may need to be re-positioned (moved from one location to another) or may need to be angled differently based on the type of aircraft and/or position of the aircraft whereby the data capture signal may also include instructions relating to camera location or camera orientation. In other embodiments, movement of the cameras may be automated or orientation of each of the set of cameras may be remotely controlled.

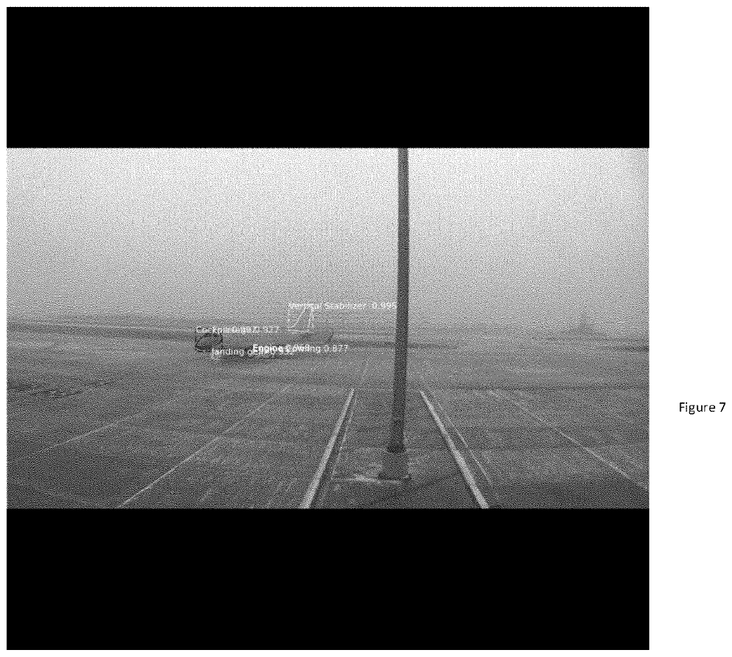

In some embodiments, the set of cameras may also detect and track aircraft movement. This is schematically shown in FIG. 7 which shows an aircraft tracked as it approaches the contamination removal location. FIG. 7 also shows the segmentation module preemptively working operating in preparation for a brake-set of the aircraft. In some embodiments, after receiving the data capture signal, the set of cameras may orient themselves to capture data for the entire aircraft and/or specific, or critical, surfaces of the aircraft. By understanding the aircraft type and position of the aircraft within the contamination removal location, each camera may adjust its pan, tilt and zoom (and other characteristics) to ensure that the data captured by the set of cameras includes all required or requested data of the aircraft, and more specifically, the critical surfaces of the aircraft.

Based on the data capture signal or signals, the set of cameras capture the requested data and transmits this data back to the controller which is then received by the controller (206). The data may then be stored in a database, such as within a server or in a Cloud-based network, prior to processing.

The data is then processed by the controller to segment the data (208). In one embodiment, the segmentation module processes the data received such that the aircraft is segmented into different sections or segments, for example, a nose segment, a body segment, a wing segment and a tail segment and the images sorted according to the different segments. In one embodiment, as briefly discussed above, the aircraft may be mapped to a 3D grid whereby different segments of the aircraft can be represented by or bounded within a set of coordinates in relation to the 3D grid. The data that is received from the set of cameras may be tagged with 3D grid coordinate information to assist in the sorting or categorizing of the data. The aircraft segments may also be represented by different colors whereby the nose segment can be displayed in a first color, the body segment can be displayed in a second color, the tail segment can be displayed in a third color and the wing segment can be displayed in a fourth color. The different colors provide a clearer image for people who are viewing the data.

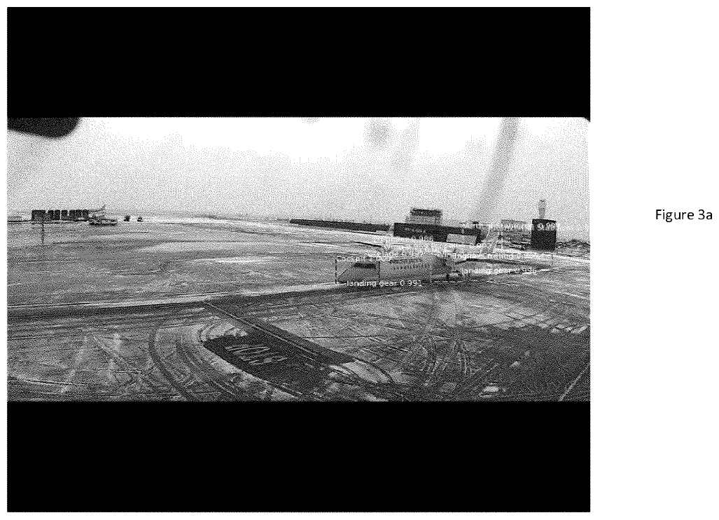

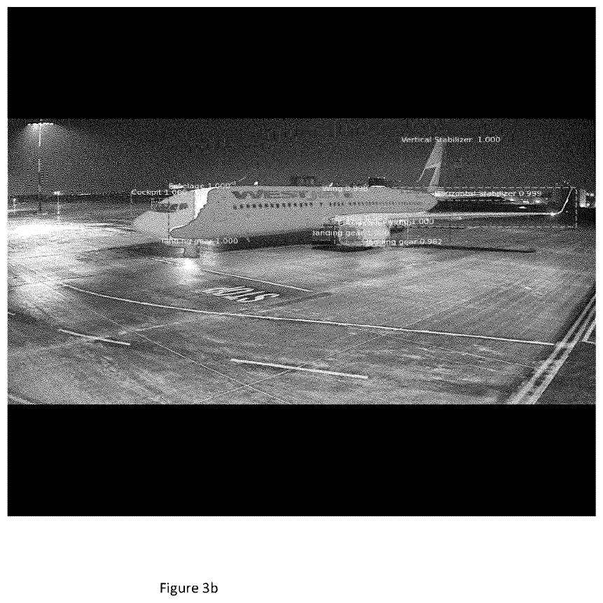

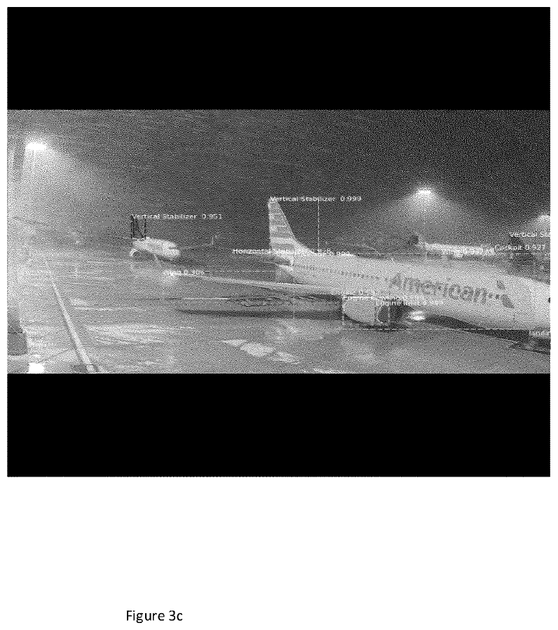

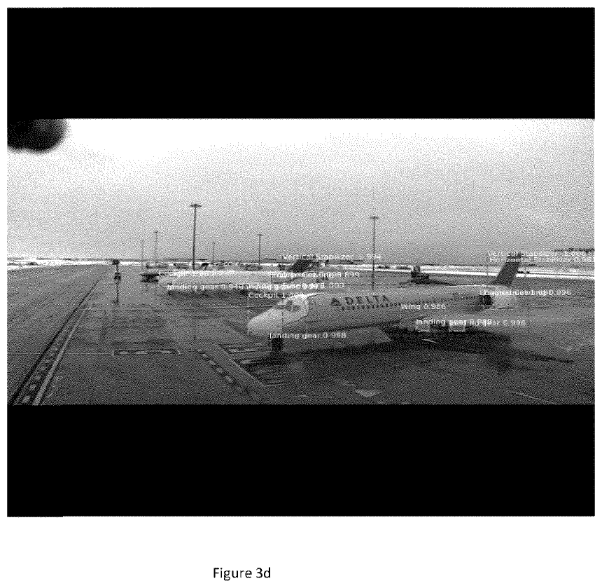

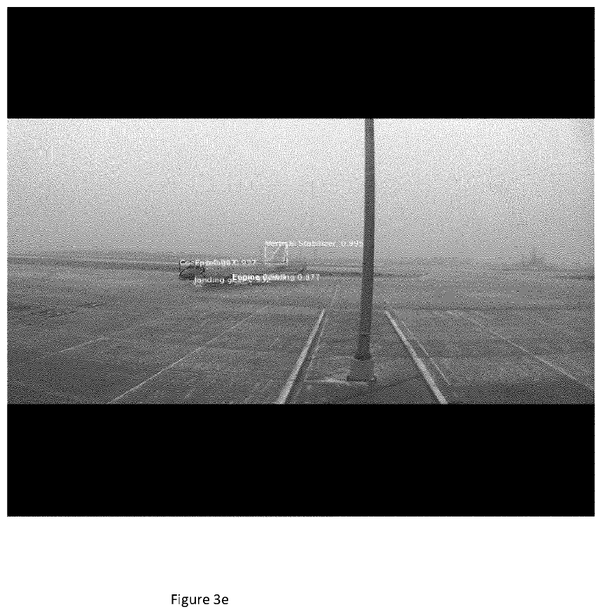

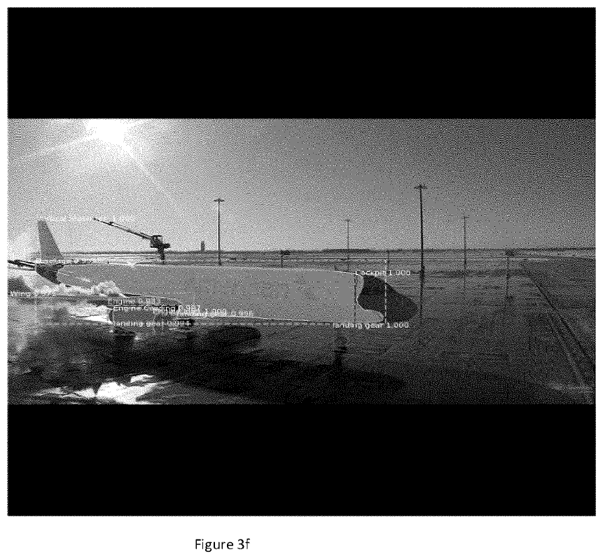

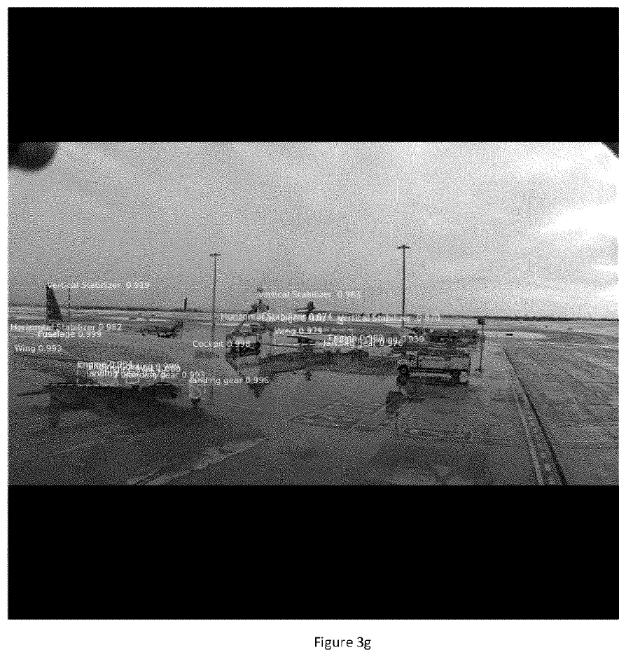

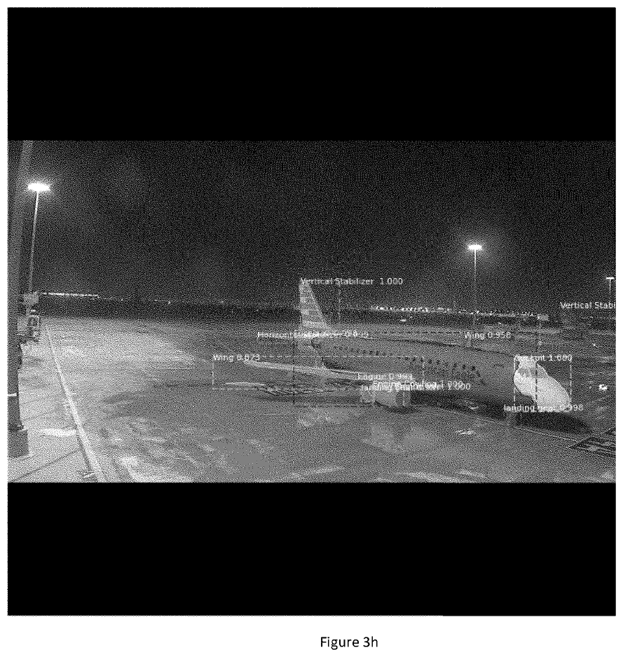

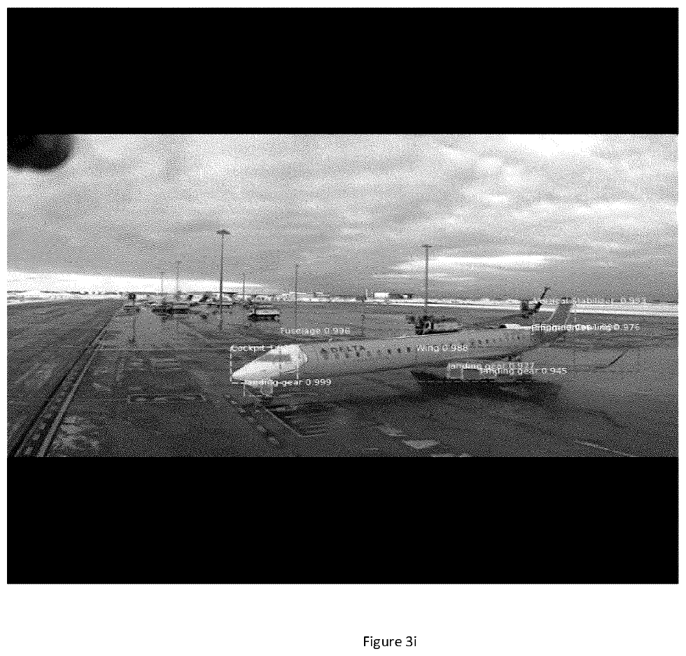

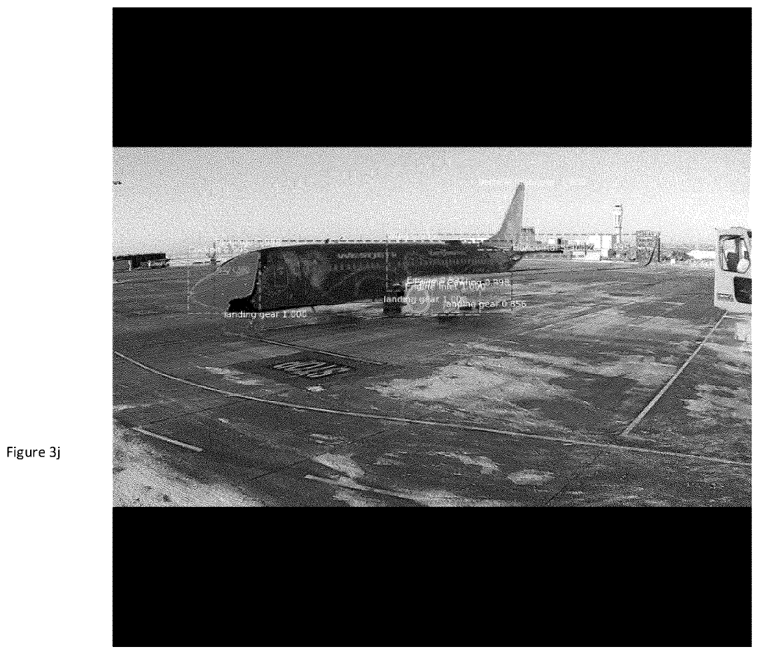

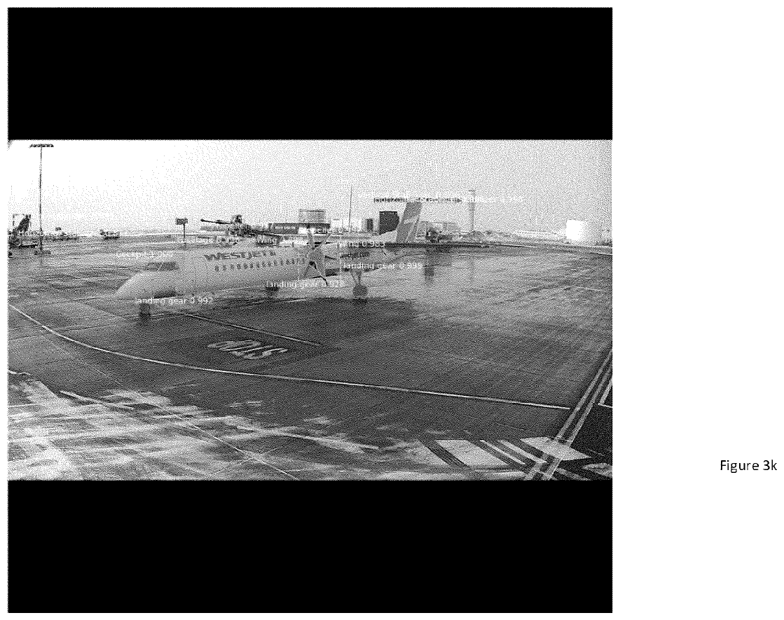

In one embodiment, the aircraft may be segmented by the system such that the cameras are provided instructions to capture specific areas of the aircraft such that the data being transmitted to the controller provides segmented images of the aircraft. In another embodiment, based on the instructions given to the cameras to capture only specific areas of the aircraft, the segmentation module segments the specific areas. In another embodiment, the data capture signal or instructions may include a request to capture data of the entire aircraft in different segments or parts of the aircraft. In another embodiment, the set of cameras may transmit the data to the controller and a segmentation module within the controller then processes the data to segment the data into different categories. It is understood that the aircraft may be segmented into other segments as well. In one embodiment, the data may be plotted to a three-dimensional (3D) graph or grid where segments of the aircraft may be represented by and/or bounded by grid graph co-ordinates. Examples of segmented data with various weather conditions are shown in the FIG. 3a to 3f.

The controller 102 then determines which segments of the aircraft should be inspected (210) such as by a pilot, dispatcher or any other designated personnel or by the system, such as via the contamination module. In one embodiment, the controller may determine that all segments should be inspected if the inspection is prior to any contamination removal treatment being performed. In another embodiment, the controller may select specific segments after a contamination removal treatment has been performed to check if the contamination removal treatment was successful. After determining the segments, the controller transmits instructions to the contamination module to inspect the data associated with the determined segments (212) or the system may transmit the data for viewing on at least one of the other communication devices.

In one embodiment, the controller transmits the data associated with the selected segments to the contamination module for processing. In other embodiments, the controller transmits grid coordinates to the contamination module whereby the contamination module retrieves the data associated with the transmitted grid coordinates. In yet another embodiment, the controller transmits the selected segments and the contamination module accesses a database to determine the grid coordinates associated with the selected segment or segments and then retrieves the data associated with the grid coordinates or segments for contamination inspection. The contamination module then inspects the data associated with the selected segments (214) or specific zones/areas within the selected segments to determine if there is any contamination. Depending on when the contamination module is processing the segmented images, the inspection may be for contamination (before contamination removal treatment) or contamination and/or fluid failure (after a contamination removal treatment).

In one embodiment, the controller may utilize heat map technology to determine a temperature or approximate temperature of the different segments of the aircraft whereby the controller determines that areas that are lower than a threshold temperature are contaminated or are still contaminated and require contamination removal treatment or a further contamination removal treatment. In other embodiments, the controller may generate and display a thermal map of the aircraft based on the images/video such that a user can review to determine if there is contamination. In another embodiment, the controller may use Al modules or models or other types of machine learning modules to determine if there is contamination on a surface of the aircraft by processing the data captured by the cameras.

In other embodiments, if the controller determines that the segmented images or video are not suitable for processing, the controller may communicate with other components, such as light sources, to improve the conditions for capturing the images/videos and may then re-instruct the cameras to re-capture a new set of data so that another set of data can be recaptured to then perform another inspection. In other words, the flowchart returns to (204).

If there is no contamination detected on the external surfaces of the aircraft, the controller transmits an “aircraft ready” message to the pilot device (216) and other airport personnel so that the pilot can then leave the contamination removal location and taxi to its runway to prepare for takeoff. The message can be transmitted to the pilot via the pilot device or may be presented to the pilot via an electronic message board that is located within the contamination removal location.

If there is contamination detected on the external surfaces of an aircraft, the controller determines a contamination removal treatment plan (218). If the inspection is taking place after a contamination removal treatment has been performed (where the inspection occurs post-de-icing), the inspection may determine if there is contamination or if there is a fluid failure and, is to, determined an updated contamination removal treatment plan.

After the treatment plan or updated treatment plan has been determined, the controller transmits a signal representing the treatment plan to the contamination removal or de-icing, apparatus device (220).

In some embodiments, the signal may be transmitted to a de-icing personnel communication device or the de-icing apparatus communication device whereby the de-icing personnel then views and performs the treatment plan. Alternatively, the signal may be transmitted directly to a de-icing vehicle which then autonomously performs the treatment plan based on the signal (treatment plan instructions) supplied by the controller. In one embodiment, the treatment plan may be a report with images identifying areas of contamination or fluid failure highlighted on the image to visually assist the de-icing personnel or de-icing apparatus (robot) to provide the contamination removal treatment. In this embodiment, it is assumed that the de-icing vehicle or deicing-autonomous apparatus understands or knows the position of the aircraft within the contamination removal location and the parts of the aircraft that require contamination removal (which may be via grid coordinates). The contamination removal vehicle or apparatus can then perform the requested treatment plan.

After completion of the contamination removal (or de-icing) treatment, the deicing vehicle or apparatus returns to a safe location within the contamination removal location and transmits a signal indicating safe location to the controller. A safe location may be seen as a location that is pre-determined within the contamination removal location whereby there is less likelihood of collision between the contamination removal apparatus and the aircraft. The safe location may also be determined by de-icing personnel parking the de-icing vehicle in a location that is not proximate to the aircraft. After parking in or moving to the safe location, de-icing personnel or the de-icing vehicle, such as via the de-icing apparatus communication device, transmits the safe location signal to the controller indicating that the treatment has been completed and that the de-icing vehicle or apparatus is in a safe location and, in some embodiments, to pass control or the contamination process back to the controller.

In the current embodiment, the controller may then transmit a signal to the set of cameras (204) to capture an updated set of data of the surface of the aircraft. The set of cameras then proceed to obtain the requested data as outlined above. An updated inspection is then performed (such as the inspection taught above) by the controller based on the updated set of data.

In some embodiments, the set of cameras may have to move from a current position to another position to capture the requested image/video. The same process is performed as discussed above to obtain data and then perform an inspection of the aircraft.

If the presence of contamination is confirmed, the controller generates another treatment plan and transmits a signal to the contamination removal apparatus device. The updated signal may include or represent the updated treatment plan based on the determination of the contamination module. In other embodiments, the updated signal may require the de-icing apparatus to perform the whole contamination removal process again (i.e. repeat the treatment plan). The integrated inspection within the contamination removal process may be repeated until it is determined that there is no more contamination and that the aircraft is ready for takeoff.

In one embodiment, the pilot in-command or dispatcher may request the captured images or video from the controller of the aircraft surfaces pre-deicing or post-deicing at the terminal gate or at the contamination removal facility. In this embodiment, the controller may only use the cameras to capture the data and not process it using the segmentation and contamination modules. The pilot or dispatcher receives the data either on the pilot device or the dispatcher computer or communication device.

In one embodiment, the disclosure may be seen as a method and system that includes the activation of a set of cameras for the capture of images and/or videos of a surface of an aircraft at different time intervals of a contamination removal process. As discussed above, data capture may take place at predetermined or desired timing intervals during the contamination removal process and may be requested by the contamination removal apparatus, the aircraft or the controller. In one embodiment, the data may be captured before the contamination removal process starts or after a contamination removal treatment is completed (to determine if it has been completed satisfactorily)

In yet another embodiment, at the end of a contamination removal treatment (after the controller has determined that the conditions on the surface of the aircraft meets a predetermined threshold), the controller may transmit the final images of the surface of the aircraft to the pilot (or other aircraft personnel) along with an indication that the aircraft has been deemed clean or ready for take-off. In other embodiments, the controller may just provide the aircraft clean or aircraft ready signal or message.

In some embodiments, the signal from the controller to the set of cameras may include instructions for the set of cameras (or a subgroup of the set of cameras) to focus on specific parts of the aircraft, such as, the wings or tail section and to calibrate to size and aircraft type automatically according to information requested by or provided to the controller. In some embodiments, once the aircraft arrives at the contamination removal location, the set of cameras may automatically adjust focus and sight lines to the aircraft entering based on the information provided by the controller that identifies the aircraft type. This may occur before (200) and (202) of FIG. 2.

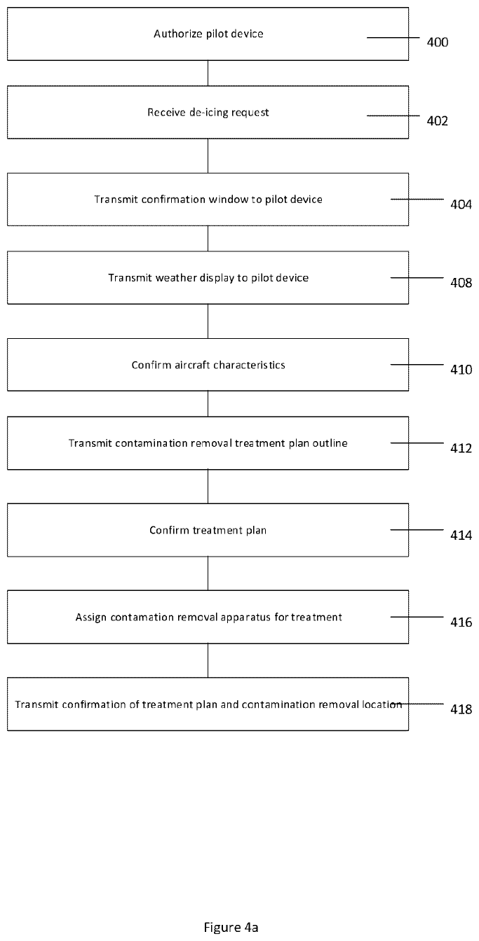

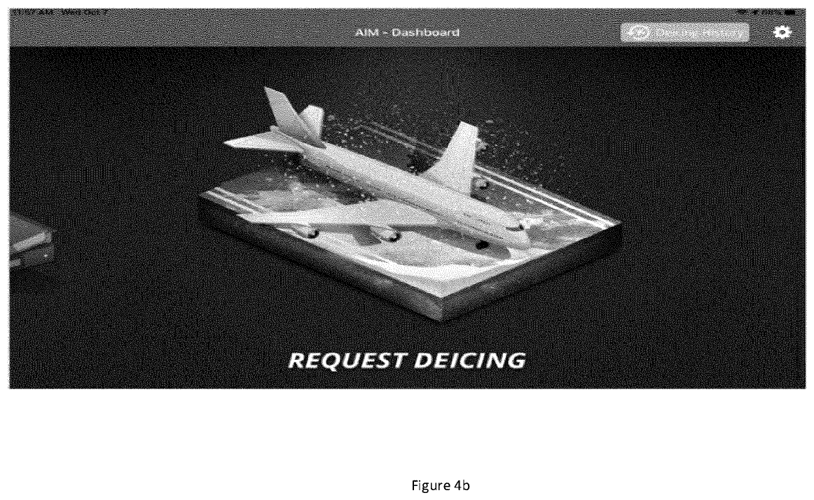

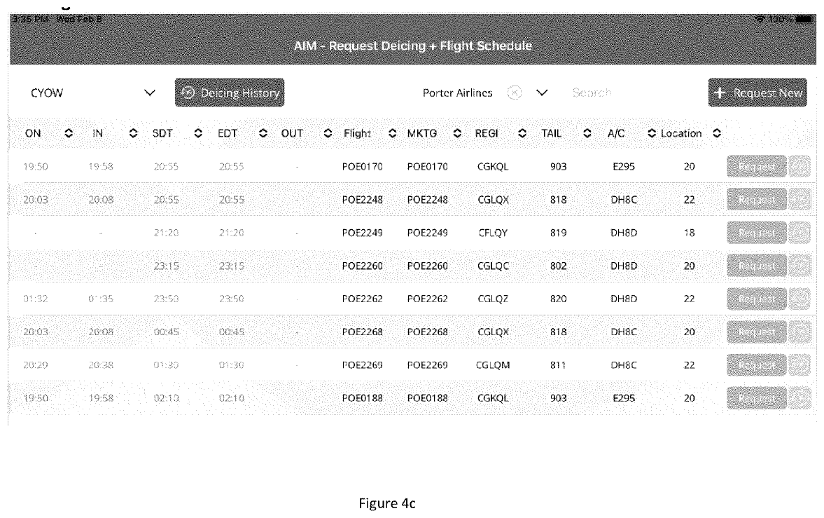

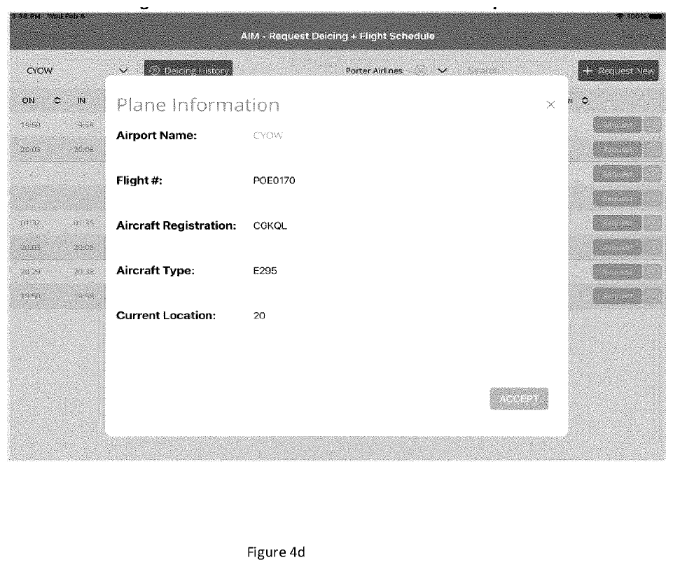

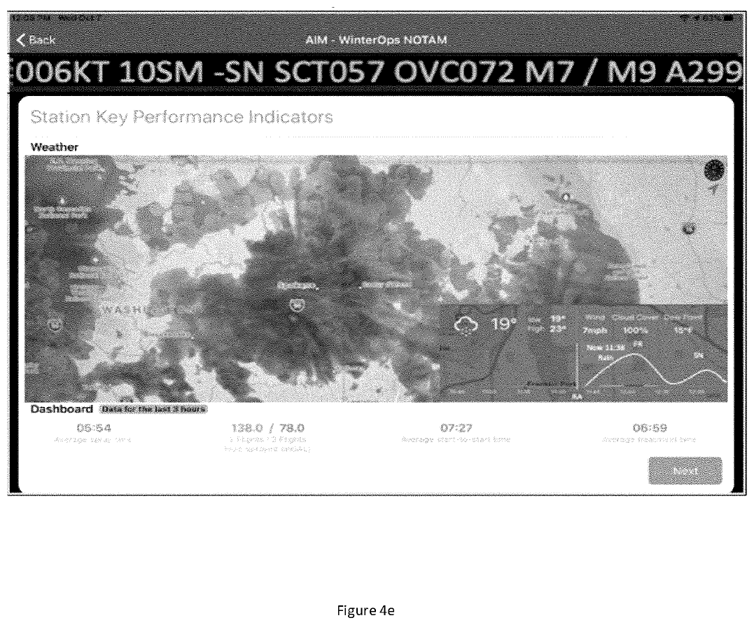

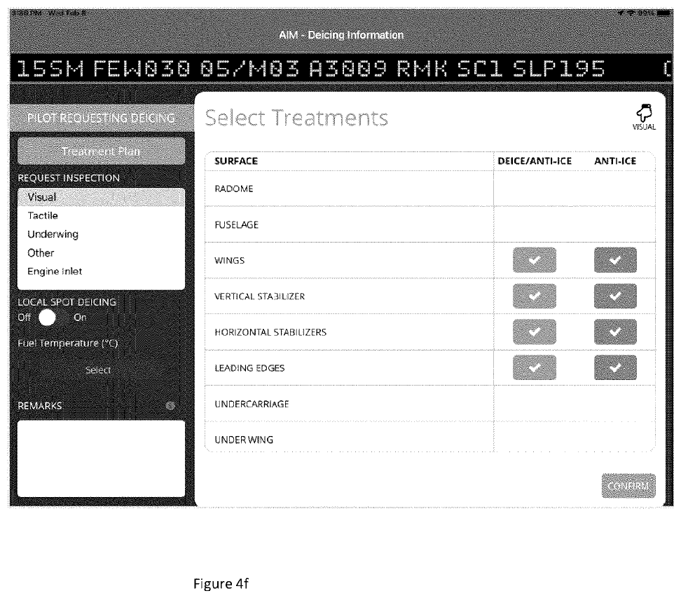

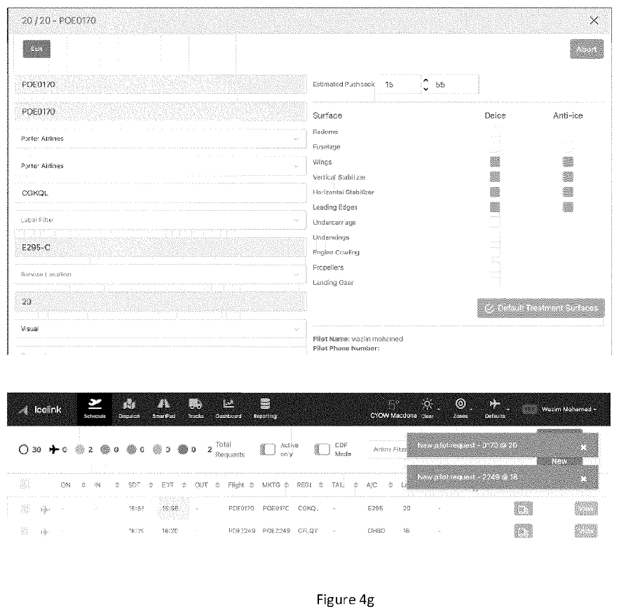

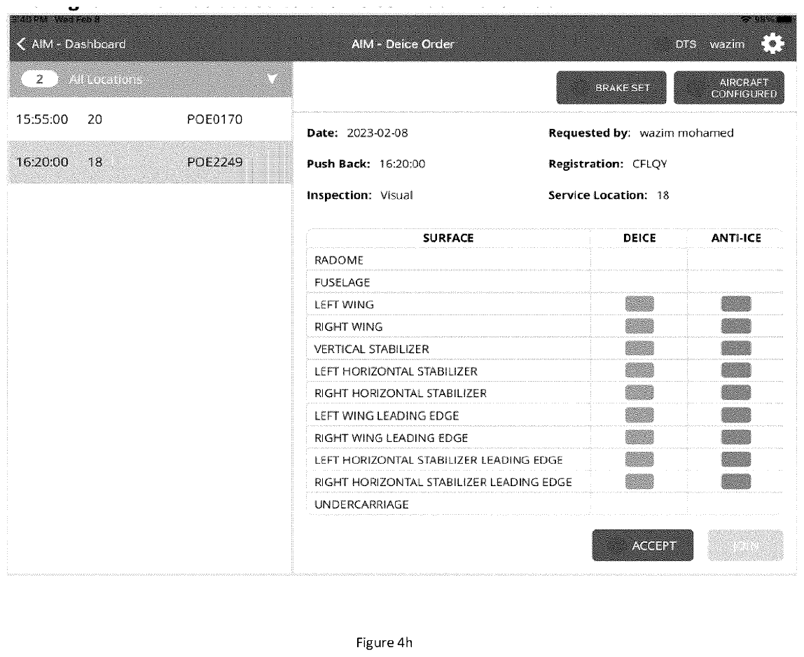

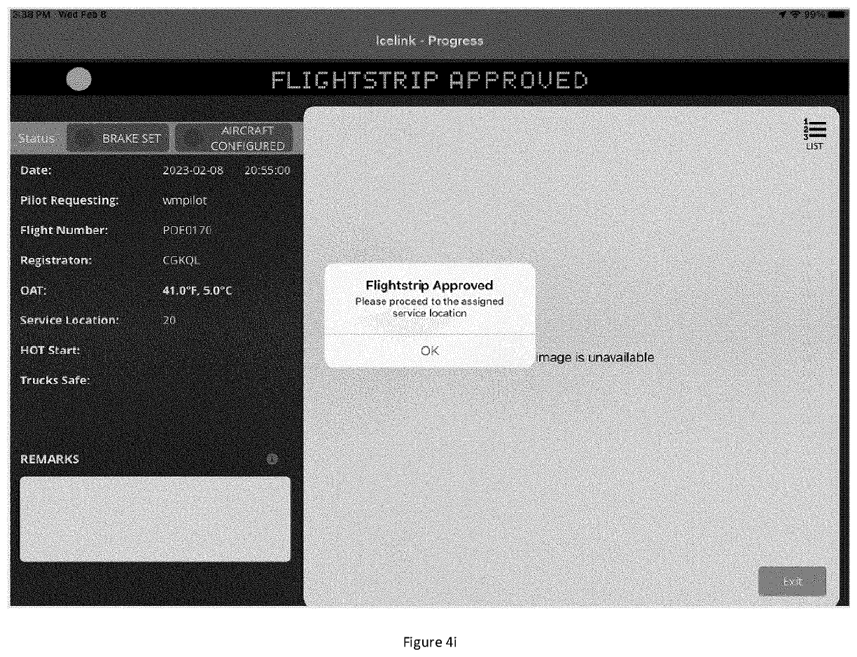

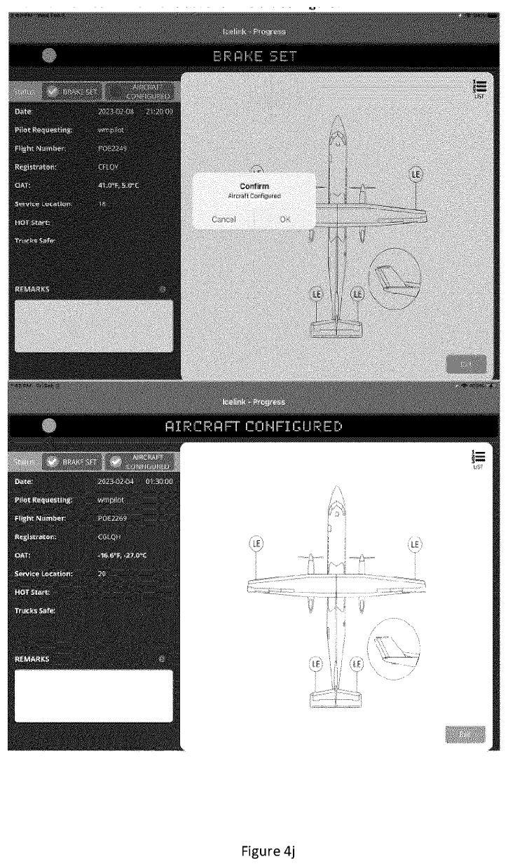

Turning to FIG. 4a, a method of transmitting coordination removal location information to a pilot device is shown. In other words, FIG. 4a shows one embodiment of (200).

Initially, a pilot logs into the system, such as via their pilot device. As discussed above, the pilot device may be seen as a wireless communication device that is associated with an aircraft and, typically, located within a cockpit of the aircraft. The pilot device allows the pilots or crew of the aircraft to communicate with a controller that coordinates an automated contamination inspection within a contamination removal process. It is understood that the pilot may also use the pilot device to communicate with other communication devices within an airport.

After the pilot device has been authorized by the controller (400) whereby the login is successful, the pilot may then communicate with the controller to request a contamination removal treatment. FIG. 4b provides an example screenshot that a pilot may see after they have logged into the system and into a contamination request component, or application.

The pilot can then submit a contamination removal treatment request which will include an indication of the airport they are located in (which is received by the controller). An example of a screen that may be displayed on a pilot device showing a flight schedule from which the pilot can request de-icing is schematically shown in FIG. 4c. The request may also include aircraft identification information such as, aircraft ID number, aircraft type, airline company, aircraft departure information and the like.

After receipt of the request (402) (such as via a click button on the pilot device), the controller then confirms the aircraft information by pushing a pop-up window (schematically shown in FIG. 4d) to the pilot device so that the pilot can confirm the aircraft characteristics by clicking an Accept button. The controller may also push a weather display to the pilot device (408) (such as schematically shown in FIG. 4e) which may provide a current METAR view along with a historical view (such as the weather for the past three hours).

After confirming the aircraft characteristics (410), the controller can then push a de-icing treatment plan window to the pilot device (412) (such as schematically shown in FIG. 4f) so that the pilot can enter the areas of the aircraft for which contamination removal is requested. In some embodiments, this may include a review of previously images captured by the set of cameras which show current contamination on the surfaces of the aircraft. After submission of the treatment plan request, the pilot then waits for confirmation or further instructions from the controller (414). As will be understood, the controller may be associated with a dispatcher that oversees operations of the entire airport and coordinates the operations. In some embodiments, if the aircraft is located at the gate, the pilot can request a contamination inspection as well and the controller determines (based on the results of the inspection) if treatment is required. In the case where the cameras are located at the terminal gate, the inspection procedure/sequence for contamination follows the same procedures outlined above in FIG. 2.

From the controller viewpoint, once the controller receives notification of the pilot's request, the controller then reviews the treatment plan or treatment type and determines the de-icing apparatus that is capable of performing the treatment. A sample screenshot of what the controller displays is schematically shown in FIG. 4g.

The controller (or the dispatcher via the controller) then assigns the aircraft a de-icing apparatus (418), such as, but not limited to a de-icing truck, to a contamination removal location. An example screenshot is schematically shown in FIG. 4h). The controller then transmits a message or signal to the pilot device confirming that a contamination removal location has been selected and informs the pilot (418). An example screenshot that may be displayed on the pilot device is schematically shown in FIG. 4i.

The pilot then maneuvers the aircraft to the contamination removal location. Once arrived, the aircraft positions itself within the contamination removal location and applies its brakes. Once the brakes are set and the aircraft configured for de-icing, a parked/brake-set, or aircraft ready, signal is transmitted to the controller (that is received by the controller). This is discussed as (202) above. Example screenshots are shown in FIG. 4j. The controller then communicates with a set of cameras to capture data of the surface of the parked aircraft (such as discussed above with respect to FIG. 2).

In some embodiments, the set of cameras capture data from all four sides of the aircraft in order to capture all critical surfaces. In further embodiments, the images processed by the contamination module may also be displayed to the pilot so that the pilot can use their judgment to request another inspection or inspection report or inform the dispatcher (via the pilot device and controller) of any concerns.

In a further embodiment, the system of the disclosure uses all the captured images to train itself to improve its accuracy and expand its knowledge database.

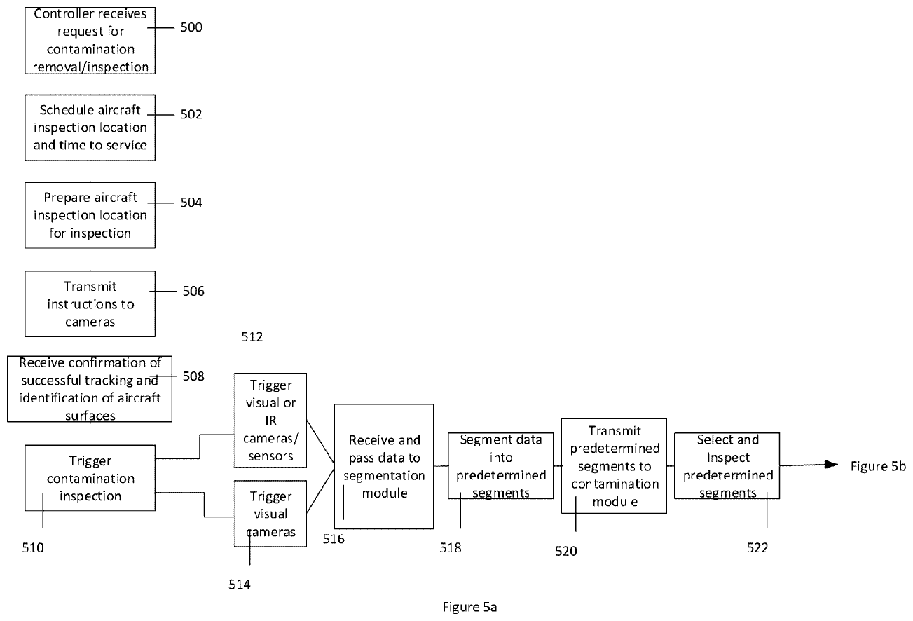

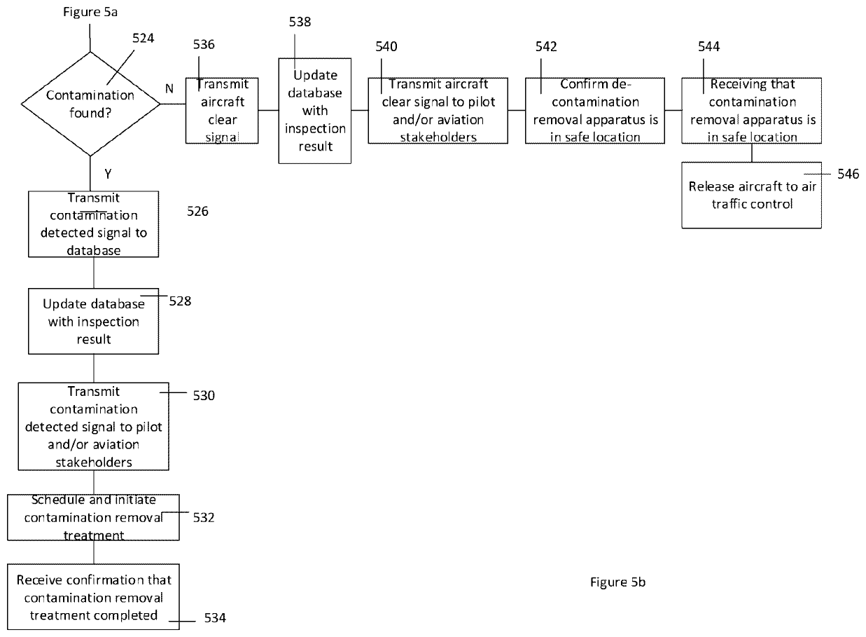

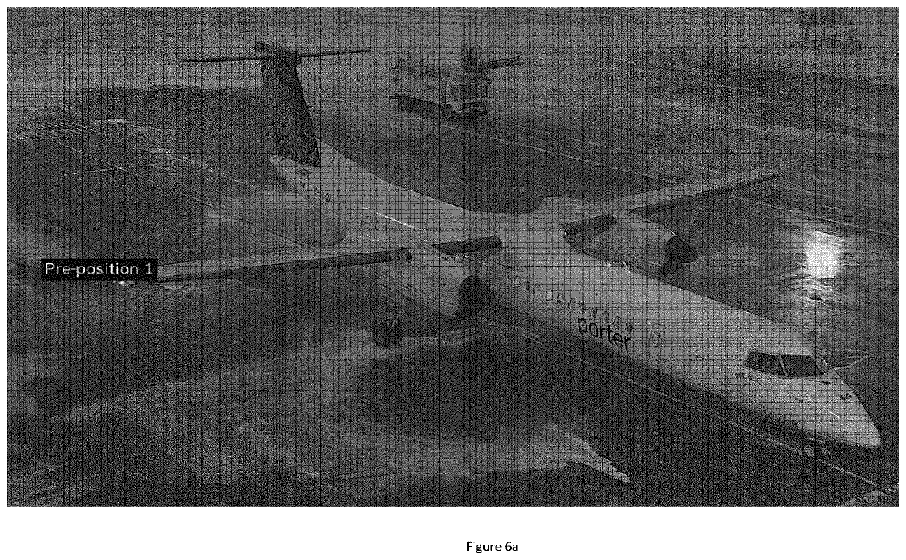

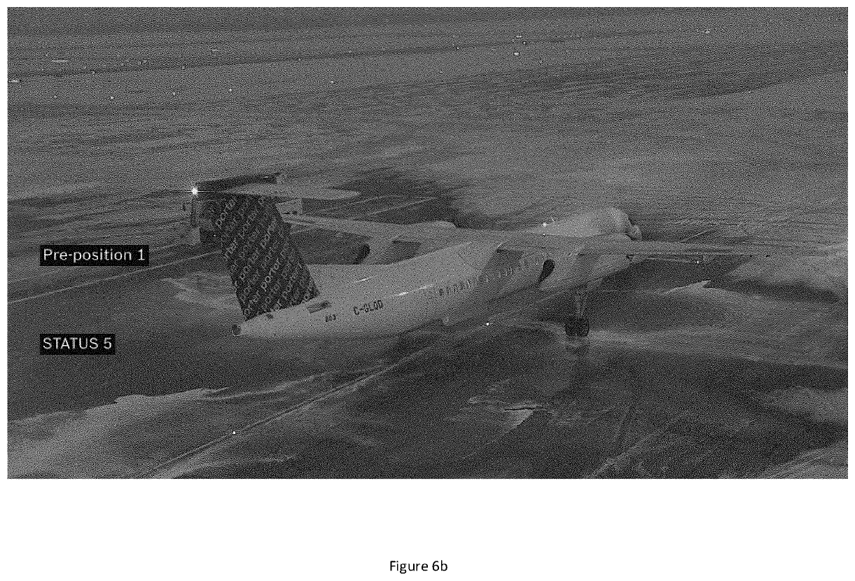

Turning to FIG. 5, a flowchart showing another method of coordinating a contamination removal process for an aircraft is shown. Initially, the controller receives a request for contamination inspection (500). This request may be transmitted by a pilot (such as via a pilot device associated with the aircraft) or from a dispatcher who is managing the flights for an airport. The controller then schedules an aircraft inspection location and time to service (502) and transmits this information to the pilot device for viewing by the pilot. After the aircraft has travelled to the aircraft inspection location, the controller identifies the aircraft type and configuration and remotely prepares the set of cameras to inspect the aircraft according to the identified aircraft type and configuration information (504). In one embodiment, when the request for contamination inspection is received, the request may include the aircraft type and configuration information whereby preparing the set of cameras may include orienting the cameras based on the aircraft type.

The controller then transmits data or instructions to the cameras (506) to identify and track the aircraft surfaces in preparation for inspection. The controller then receives confirmation of successful tracking and identification of the aircraft surfaces (508). The controller then triggers or initiates the contamination inspection (510). In one embodiment, the controller may transmit a signal to the set of cameras to start obtaining the data such as via a data capture signal.

In one embodiment, the controller may trigger cameras (visual, thermal or infrared) or sensors (512) or the controller may trigger visual inspection cameras (514). After triggering the cameras, the controller receives captured images or videos from the cameras and passes the received data to a set of AI models or modules (516) such as the segmentation module. The segmentation module then processes the data to segment the data into predetermined segments (518) to assist in the identification of aircraft critical surfaces (surfaces which still have contamination). The segmentation results (or the segmented data) of all the critical surfaces are then exported or transmitted to a contamination module (520). The contamination module (which is part of the controller) then uses the information from the segmentation module to focus only on areas of interest by selecting the predetermined segments from the set of segmented data and then inspecting the areas of interest, critical surfaces, or selected segments for contamination (522). A check is then performed to determine is there has been any contamination found on a surface of the aircraft (524) as schematically shown in FIG. 5b.

If contamination is detected, a signal or message is transmitted to a database (526), such as, but not limited to, a cloud based server to keep records of images, flight data and inspection results (528). A contamination detected signal (with or without images with identified contamination zones) is then transmitted to the pilot device and/or aviation stakeholders (530).

The controller then schedules the aircraft for a contamination removal treatment (532). This may include informing the pilot and deicing facility of an incoming aircraft. The controller then transmits a signal or message to an autonomous contamination removal device or de-icing personnel controlling the contamination removal device with information, such as a map, showing the critical surfaces that have contamination and a treatment plan. Once completed, the controller receives an indication that the deicing treatment has been completed (534). The controller can then transmit a signal to the cameras to identify and track the aircraft surfaces in preparation for a further inspection (510).

If there is no contamination detected by the contamination module after the contamination removal treatment has been completed, an aircraft clear signal is transmitted to a database (536) such as, but not limited to, the cloud based server or a server to keep records of images, flight data and inspection results (536). An aircraft clear signal and/or image is then transmitted to the pilot device and/or a no contamination detected signal is transmitted to aviation stakeholders (540). The controller then communicates with de-icing personnel or directly with the de-icing device to confirm that the de-icing apparatus is in a safe zone (542). Once a safe zone confirmation signal or message is received by the controller (544), the controller release the aircraft to air traffic control (546).

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for coordinating a contamination removal treatment for an aircraft comprising:
receiving a signal indicating the aircraft is ready for the contamination removal treatment;
obtaining images or video of surfaces of the aircraft at a location for performing contamination removal treatment;
processing the images or video to determine if there is any contamination on the surfaces of the aircraft; and
determining if there is a need for performing contamination removal treatment.

2. The method of claim 1 further comprising, before receiving a signal:
receiving a request for the contamination removal treatment;
determining the location for performing the contamination removal treatment; and
transmitting a signal to the aircraft, the signal including the location for performing the contamination removal treatment.

3. The method of claim 1 wherein obtaining images or video of surfaces of the aircraft comprises:
capturing images or video of external surfaces of the aircraft using thermal or infrared cameras.

4. The method of claim 3 wherein processing the images or video comprises:
processing the images or video using heat map technology to determine temperatures of surfaces of the aircraft;
determining if any of the determined temperatures meet a predetermined criteria; and
determining a further contamination removal treatment is required if the determined temperatures do not meet the predetermined criteria.

5. The method of claim 1 wherein processing the images or video comprises:
processing the images or video to determine a level of contamination on surfaces of the aircraft; and
requesting a further contamination removal treatment if the level of contamination on the surfaces of the aircraft do not meet a predetermined criteria or providing an aircraft ready signal if the level of contamination on the surfaces of the aircraft meet the predetermined criteria.

6. The method of claim 5 wherein processing the images or video to determine a level of contamination on surfaces of the aircraft comprises:
processing the image or video using artificial intelligence (AI) models.

7. The method of claim 1 wherein processing the images or video comprises:
segmenting the aircraft into different aircraft zones; and
sorting the images or video into the different aircraft zones.

8. The method of claim 7 wherein processing the images or video further comprises:
receiving a request for processing at least one of the images or video of one of the different aircraft zones; and
determining a level of contamination on surfaces of the aircraft within the different aircraft zones; and
requesting a further contamination removal treatment if the level of contamination within at least one of the requested different aircraft zones do not meet a predetermined criteria or providing an aircraft ready signal if the level of contamination within all of the requested different aircraft zones meet the predetermined criteria.

9. The method of claim 1 before receiving a signal indicating the aircraft is ready for the contamination removal treatment comprising:
determining a contamination removal treatment plan.

10. A system for coordinating a contamination removal treatment for an aircraft comprising:
a set of cameras located at a contamination removal treatment location;
a controller for communication with the set of cameras to obtain images or video of surfaces of the aircraft and for processing the images or video to determine if there is contamination on the surface of the aircraft after the contamination removal treatment.

11. The system of claim 10 wherein the controller comprises:
a communication module for communicating with other communication devices; and
a contamination module for processing the images or videos.

12. The system of claim 11 wherein the controller further comprises:
a segmentation module for sorting the images and videos into different aircraft zones.

13. The system of claim 10 further comprising:
a contamination removal apparatus communication device for communicating with the controller to perform the contamination removal treatment.
